(19) United States
(12) Patent Application Publication
(10) Pub. No.: US 2023/0027652 A1
(43) Pub. Date: Jan. 26, 2023

(54) Personal Security System and Method

(71) Applicant: Rohan Tilak Liyanaractchi, Brunswick (AU)

(72) Inventor: Rohan Tilak Liyanaractchi, Brunswick (AU)

(21) Appl. No.: 17/783,258

(22) PCT Filed: Dec. 7, 2020
(86) PCT No.: PCT/AU2020/000134

§ 371 Date: Jun. 7, 2022

(30) Foreign Application Priority Data
Dec. 7, 2019 (AU) 2019904663

(51) Int. Cl. H04N 7/18; G06Q 20/32; G06Q 20/04; G06Q 50/30

(52) U.S. Cl. CPC H04N 7/188; H04N 7/181; G06Q 20/322; G06Q 20/047; G06Q 50/30; H04L 51/10

(57) ABSTRACT

A personal safety system comprising: a personal electronic device carried by an individual having one or more sensors for recording visual and/or audio data associated with the individual; at least one external service nominated by the individual to be in electronic communication with the personal electronic device to receive and store the recorded visual and/or audio data from the personal electronic device in real time for monitoring purposes; and wherein, the visual and/or audio data is continuously recorded in discrete predetermined intervals by the personal electronic device and at the completion of each discrete predetermined interval the visual and/or audio data for that discrete predetermined interval is transmitted to the external service together with data capturing the time and location of the individual, and following transmission of the visual and/or audio data, the data is deleted from the personal electronic device.

### RELATED APPLICATION(S)

The present application claims priority for Australian Provisional patent Application No. 2019904663, the entire contents of which are incorporated herein by reference.

### FIELD OF INVENTION

The present invention relates generally to a system and method for improving personal safety, and in particular, to a system and method that improves the personal safety of individuals as they perform a variety of tasks through the use of personal electronic devices to record transactions and interactions of the individual.

### BACKGROUND OF THE INVENTION

In an increasingly busy and mobile society, there is a need to provide easy access of individuals to services and sites to provide an enhanced degree freedom and personal wellbeing. With such an increase in movement and access of individuals to services and places at any hour of the day, there is an increased chance that the individual's personal safety may be compromised.

This is particularly the case in relation to transport services, such as ride sharing services including taxi cabs and UBER® services, where access to the vehicles is easily provided despite very little knowledge of the driver of the vehicle and their trustworthiness. As a result, at the commencement of any such travel transaction the passenger provides a degree of trust in the driver's professionalism and honour to deliver them to their desired destination. Similarly, the driver also places a degree of trust in the passenger that they will act appropriately whilst in the vehicle and pay the fare at the end of the trip.

A variety of systems have been proposed to improve the anonymity of the transaction between driver and passenger, such as displaying the drivers photo and credentials in the vehicle and the use of prepayment mechanisms to secure an electronic monetary transaction for the trip. Cameras have also been placed in vehicles to record passengers behaviour during the trip, however, these have mainly been used to record any misdemeanors after they have taken place, which is largely too late. In more recent ride sharing services, smart phone applications have been developed for both drivers and passengers to identify each other at the commencement of the journey, which have improved the perceived safety of the experience.

Despite these developments, once the trip has commenced there are few safety mechanisms available to protect the driver and passenger, should the need arise. If the driver has used fake identification or has ill-intentions toward the passenger, after the trip has commenced the driver can simply disconnect the on-board camera, thereby removing any possibility that their action will be recorded, thus placing the passenger's safety in jeopardy.

Similarly, for many individuals who may exercise or travel alone, such as children travelling to and from school as well as security guards or others that may work night shifts or the like, there is a constant threat of potential danger from others. Various personal safety devices such as alarms and the like have been proposed to be carried by such individuals to signal an alarm to ward-off threats and deter potential attackers. However, such systems require a degree of vigilance by the individual to not only identify the threat but to also ensure that the threat is real before activating the alarm. In many instances there may be insufficient reaction time for the individual to activate the alarm or identify the actual risk they may be in, which may place their personal safety in significant danger.

There is a need to provide a system and method that better captures the details surrounding the transaction between the driver and the passenger in a simple and fast manner and which provides an ongoing recordal of the transaction until the trip has been safely completed. Similarly, there is a need to provide a system and method that provides continual monitoring of an individual's environment as they go about their tasks without requiring constant vigilance. Such a need is not only to provide a system for monitoring individual safety but also to act as a deterrent to potential attackers or wrong-doers due to the likelihood of being identified and recorded in the act.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

According to a first aspect of the present invention, there is provided a personal safety system comprising:
a personal electronic device carried by an individual having one or more sensors for recording visual and/or audio data associated with the individual;
at least one external service nominated by the individual to be in electronic communication with the personal electronic device to receive and store the recorded visual and/or audio data from the personal electronic device in real time for monitoring purposes; and
wherein, the visual and/or audio data is continuously recorded in discrete predetermined intervals by the personal electronic device and at the completion of each discrete predetermined interval the visual and/or audio data for that discrete predetermined interval is transmitted to the external service together with data capturing the time and location of the individual, and following transmission of the visual and/or audio data, the data is deleted from the personal electronic device.

The at least one external service nominated by the individual may be in electrical communication with the personal electronic device by way of an email address, such that the recorded visual and/or audio data may be transmitted to the at least one external service from the personal electronic device by email.

The personal electronic device may be activated to commence recording visual and/or audio data by the individual selecting a dedicated emergency button for a pre-determined time. Upon selection of the dedicated emergency button on the personal electronic device, the personal electronic device may further record the geo-location, time and date data of the recording for transmission to the one or more external services.

The personal electronic device may be configured to communicate with one or more body worn sensors to receive the visual and or audio data associated with the individual. The one or more body worn sensors may be mounted on clothing worn by the individual or items carried by the individual.

The individual may be able to set the discrete time intervals in which the visual and/or audio data may be recorded and transmitted to the external service.

Immediately after transmission of the visual and/or audio data to the remote service, a new discrete predetermined interval of visual and/or audio data may be commenced.

Accordingly, in another aspect of the invention there is provided a method for improving personal safety and security of individuals involved in a transaction comprising:
configuring a personal electronic device of each individual to contain personal information about said individual;
assigning each personal electronic device with a unique identifier to be used to facilitate engagement between each individual's personal electronic device;
initiating transaction upon engagement between each individual's personal electronic device, such that:
   the other individual's personal information is displayed and stored on the individual's personal electronic device;
   an audio or video recording is initiated on the individual's personal electronic device to record the transaction; completing transaction between the individuals such that:
   payment is transmitted between the engaged personal electronic devices of the individuals;
   a receipt is transmitted between the engaged personal electronic devices of the individuals confirming received payment;
   the receipt, personal information of the other individual and the video or audio recording of the transaction is transmitted to a nominated storage facility of the individual; and
   the personal electronic devices the individuals are disengaged to complete transaction.

In one embodiment, the transaction may be between a driver of a vehicle for hire and a passenger intending to hire said vehicle.

The driver's personal information may include registration details of the vehicle, license details of the driver and authorisation details of the driver.

The passenger's personal information may include formal photographic identification of the passenger and intended destination of the passenger.

### BRIEF DESCRIPTION OF THE DRAWINGS

The invention may be better understood from the following non-limiting description of preferred embodiments, in which:

FIG. 1 is a functional diagram of an exemplary system for enhancing security of individuals in a transaction;

FIG. 2 is flow chart depicting a method of setting-up the system of FIG. 1 on a smart phone;

FIGS. 3-6 are screen shots depicting the steps of the invention as shown in FIGS. 2 and 3;

FIG. 7 is a depiction of an enhanced visual recording system in accordance with an embodiment of the present invention;

FIG. 8 shows an embodiment for using the enhanced visual recording system of FIG. 7; and

FIG. 9 shows an alternative embodiment for using the enhanced visual recording system of FIG. 7.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to a system and method for enhancing driver and passenger safety in a vehicle ride sharing situation, such as a taxi or Uber® service. However, it will be appreciated that the system and method of the present invention could be employed for use in a variety of situations where the safety and integrity of individual may be compromised. In this regard, the system and method of the present invention could be readily adapted for use in shops and other trading places to monitor and legitimise the transaction between the shopper and the store owner to ensure that the integrity of both parties is maintained. Similarly, the system and method of the present invention could be employed in restaurants and pubs/clubs to provide a simple and effective means for providing identification of customers as required by the owner of the establishment.

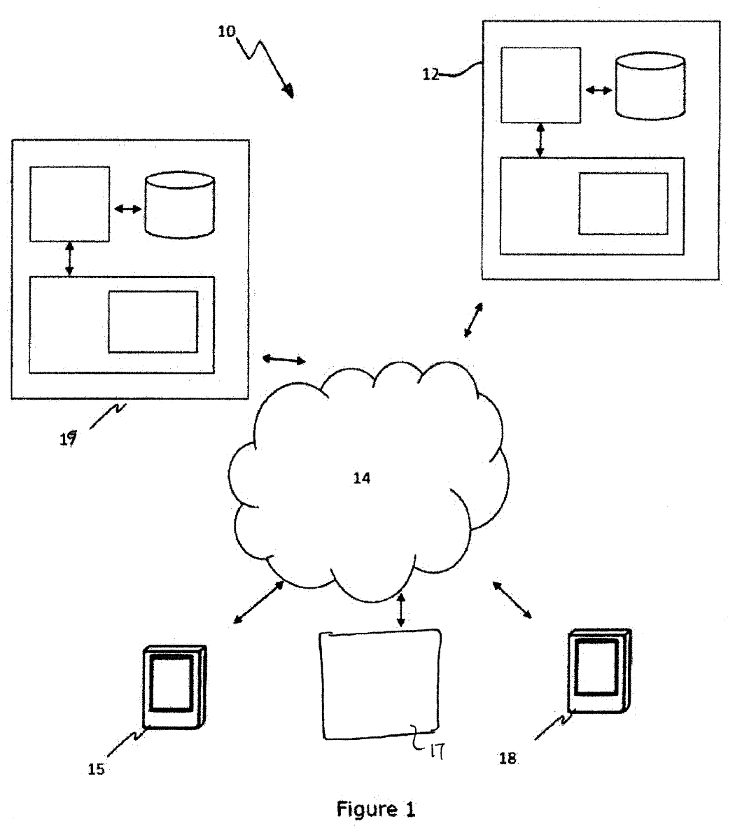

FIG. 1 illustrates a functional diagram of an exemplary system 10 within which the present invention may be embodied. The system 10 comprises a passenger service 15 and a driver service 18, which are able to communicate with each other over a wireless network 14 and which are each able to communicate with associated remote servers 12 and 17 to capture and record data associated with the transaction, typically a ride in a vehicle.

The passenger service 15 and the driver service 18 are typically smart phones that have a software application operating thereon, in accordance with the present invention. The software application may be downloadable by the owner of the passenger service 15 or driver service 18 from a dedicated store or host server 19 via the network 14 in a conventional manner.

In a preferred embodiment, the network 14 maybe the internet or a dedicated mobile or cellular network in combination with the internet, such as a GSM, CDMA, UTMS, WCDMA or LTE networks and the like. Other types of networks such as an intranet, an extranet, a virtual private network (VPN) and non-TCP/IP based networks are also envisaged. The passenger service 15 and driver service 18 may also be able to communicate wirelessly via Bluetooth® or other similar wireless networks.

Each of the passenger service 15 and driver service 18 is able to communicate with a dedicated remote server 12, 17 to record and store information as required. Typically, the remote server may be an email server associated with the user of the passenger service 15 or driver service 18 which may be hosted externally to store content for later downloading by the user to a personal storage device or a cloud storage device.

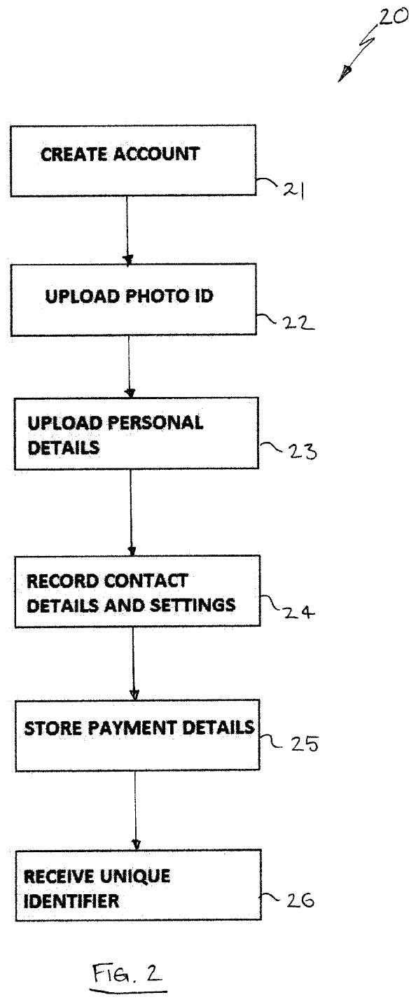

In order to obtain the software application for operation by the operating system of the passenger service 15 or driver service 18, the user will typically be required to register their service with the host service 19 in accordance with the method 20 as depicted in FIG. 2.

In step 21, after downloading the software application to their service 15, 18, the user creates an account with the host server which acts to configure the software application on their service 15, 18. The user will create a username and password for accessing the application and may provide some biometric ID, such as a photo, which will be scanned by facial recognition technology to provide additional security for the system.

In step 22, the user will then upload an official photographic identification that confirms their identity, which may be a photograph of the user's driver's license or passport, or any other acceptable form of photographic ID that confirms their identity. The purpose of the capturing the photographic ID enables the image to be stored on the device for use during the initial stages of any transaction. In this regard, the photographic ID stored on the device may be displayed to the driver/passenger at the commencement of a trip and only the license number of passport number transferred between the driver/passenger as part of the transaction. The ability of having an electronic version of the user's ID available for display by the software on request provides a simple means for ID verification that can also be used in pubs/clubs and the like, as required.

In step 23 the user is required to upload their personal details including name and address as well as the details of the photographic ID loaded in step 22, typically their license number or passport number. This will then be checked against their photographic ID as a means for confirming the integrity of the data stored against the user's profile.

In step 24, the user enters their contact details, or preferred contact details to which files will be sent as part of the transaction. The user may record as many as 5 email addresses and text addresses to receive transaction date, such as driver/passenger identification details, trip details, payment receipts, shopping receipts and the like. Also, any video recordings taken by the system as part of the transaction recordal system will be sent to the user's nominated email system. In this regard, as part of this step 24, the user may set their preferences as to how video and audio recordings of the transaction may be governed. The user may decide to set a condition by which, as a default, every time the system is activated video and audio recordings will be activated to record the vehicle trip or shopping venture and how long the recording will continue after successful completion of the transaction.

In step 25, the user will enter their preferred payment settings, such as their credit card details, for controlling how each transaction is to be made. As part of this function, the user can set the currency that the transactions are to occur in as well as any limits or charges that are to be applied to the transaction.

Upon completion of step 25, the host server will provide the user with a unique identifier, such as a QR code, which can be displayed by the user on their service at the commencement of a transaction. This identifier can then be used for scanning by the other user, such as the passenger or driver, to initiate the transaction and initiate transfer of information between the users.

The manner in which the system of the present invention may be used in a ride share situation is depicted as follows:

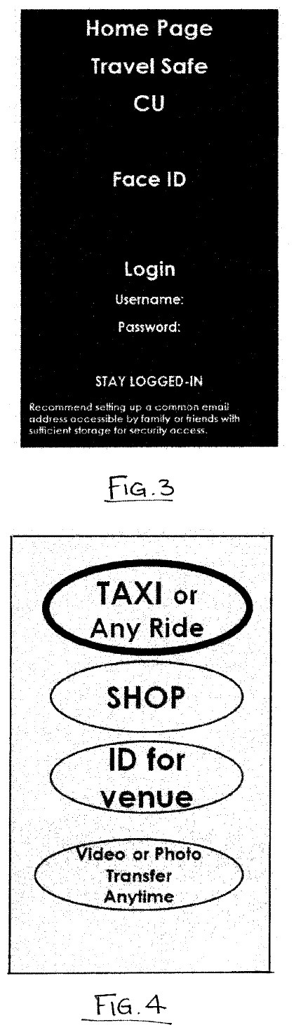

The passenger will initiate their software application on their personal device prior to entering the vehicle. This is achieved by facial recognition or by entering a password into the user interface of the application on their device as depicted in the screen shot of FIG. 3.

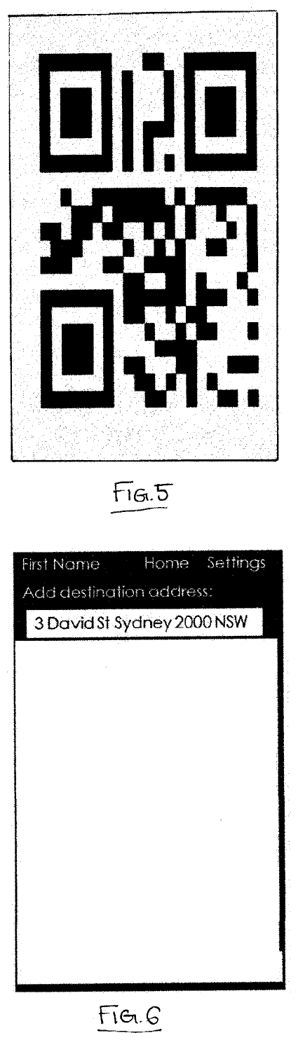

Following activation of the software application, the passenger will then choose the appropriate transaction from the list provided on their screen, as depicted in the screenshot of FIG. 4. For a ride share transaction the user will select the appropriate icon at which point their unique identifier will be displayed to initiate the transaction, as depicted in FIG. 5.

Both the passenger and the driver will then use their devices to scan each other's unique identifiers. This will then capture the relevant details of both parties in their respective devices, such as the name and details of the passenger, the name and details of the driver together with the driver's registration number and vehicle identification details. In this regard, the vehicle may also have a QR code displayed which can be scanned by the passenger together with the driver's QR code. Both the passenger and the driver can then check the identification details of each other to ensure that the individual identity of each party is validated.

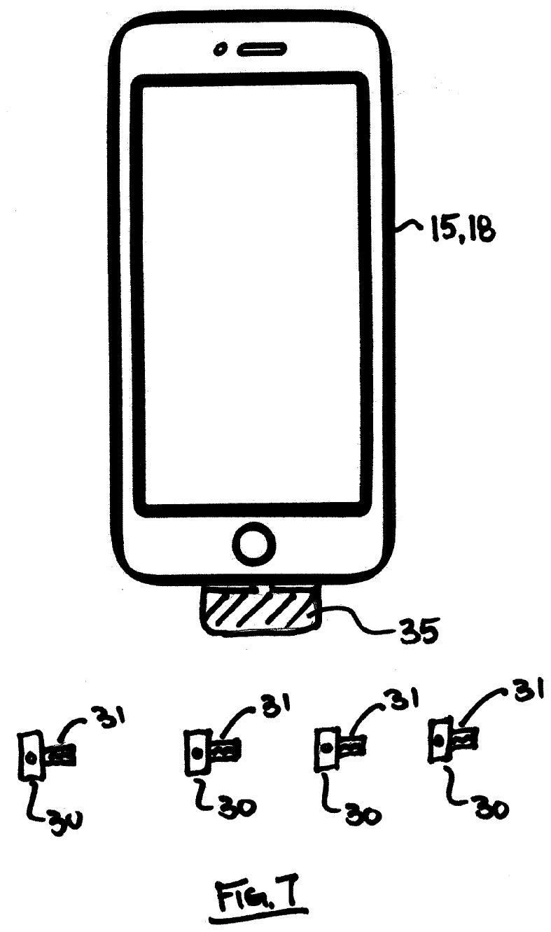

Once the driver accepts the ride from the passenger, the details of the parties are then captured and transmitted to the nominated contact destination, such as the email address nominated by the individual. The driver's software application will typically be provided with an ACCEPT icon to initiate this step. The acceptance of the transaction may also trigger both the driver's and the passenger's video and/or audio recording facilities to commence recording the environment, which may capture the entire trip. Prior to acceptance, the passenger will enter their destination address as depicted in FIG. 6, which will also be captured and transferred with the other data as a record of the transaction.

Upon commencement of the trip, a live map will be generated on the passenger's and driver's device depicting the route taken by the driver which can also be captured and sent to the passenger's email address for confirmation of the route taken. Throughout the journey a video and audio recording may be taken by both the passenger and the driver for safety purposes.

Upon arrival at the destination, a receipt will be generated by the driver's service that captures the start and end time of the trip together with the charge. This will be transferred to the passenger's device where the passenger may authorise payment via their nominated payment method, and a record will then be made of the successful payment. Upon successful payment and exit of the passenger from the vehicle, the video/audio recording may be discontinued and the connection between the driver's device and the passenger's device discontinued. At this point the video/audio recording will be emailed to the user's nominated account for storage by the user, as required.

It will be appreciated that a copy of the user's personal photographic ID, such as their license or passport, will not be transferred to the other user. The stored copy of the photographic ID will simply be made available on the user's screen for inspection by the other user as a means for confirming the identity of the other user. This will ensure that personal details will not be shared where such details could result in identity theft.

For both the passenger and the driver, during the trip the software application on their service will display an emergency icon which can be selected by the passenger/driver should they feel unsafe or feel that their safety is compromised. The emergency icon may comprise two buttons formed on the user interface which are required to be pressed together by the driver/passenger for a predetermined period, such as 3-5 seconds, to engage an emergency state of operation.

The emergency state of operation will call the emergency number set by the user during registration of their device, which may be an emergency services line such as 000 or 911, or may be a number of a friend or guardian. The GPS position of the vehicle as well as the identification details of the vehicle/driver and passenger will then be emailed or texted to the predetermined contacts set by the user, together with a HELP or EMERGENCY message. The emergency state will also initiate the video/audio recording mode of the user's device to further enhance the user's safety.

It will be appreciated that the provision to initiate an emergency state whilst travelling will provide increased security to both the driver and passenger as it will inform authorities of the position of the vehicle and the details of the passenger and driver, as collected prior to commencement of the journey. In such a manner, the relative authorities are able to act swiftly with full information about the situation that requires their intervention.

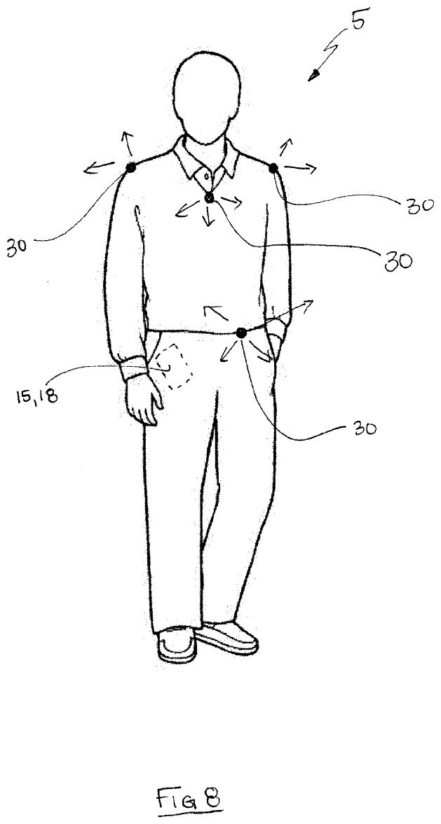

In a preferred form, the system utilises the camera(s) present on the user's smart phone device to capture the appropriate video/audio recordings. However, as depicted in FIG. 7, the system of the present invention can be further enhanced through the provision of multiple cameras that communicate with the user's device 15, 18. As is depicted, a plurality of pin-hole cameras 30 can be configured to communicate with the software application of the present invention by way of a plug-in controller 35. The plug-in controller 35 has an internal electronics configured to communicate with the software application installed in the user device 15, 18. The plug-in controller 35 is also configured to wirelessly communicate with the pin-hole cameras 30, via Bluetooth® or the like, so as to receive video image therefrom. The video image is able to be processed by the software application of the present invention where it is able to be recorded and forwarded to the user's dedicated email address, in the manner as described above.

It will be appreciated that whilst the plug-in controller 35 is depicted as communicating wirelessly with the pin-hole cameras 30, the connection could also be a wired connection by way of individual wired connectors attaching the plug-in controller 35 with the pin-hole camera 30.

Each pin-hole camera 30 may be configured to have a mounting member 31 to facilitate mounting of the camera 30 to a surface. In the embodiment as shown in FIG. 7, the mounting member 31 is a clip for removably attachment of the camera 30 to a surface. However, it will be appreciated that other mounting members that detachably mount the camera 30 to a surface are also envisaged.

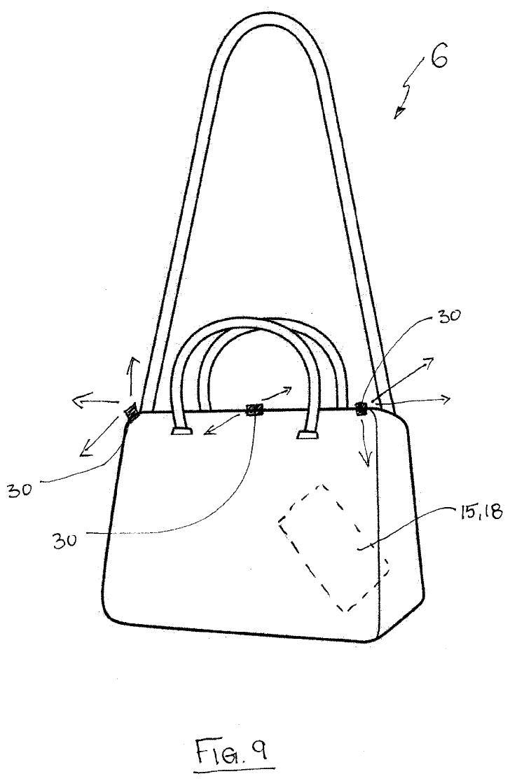

As is shown in FIG. 8, the pin-hole cameras 30 may be mounted on the body of the user 5, namely by attachment to the user's clothes. This enables the user 5 to employ the system of the present invention to take 360° images of their immediate environment, as depicted by the arrows. By mounting the cameras in such a manner the user 5 is able to carry their device 15, 18 in their pocket or the like, which is able to capture the images taken from each of the cameras 30 as they go about their normal business. Thus, should an issue arise, the user is able to access the video or still images taken by the cameras 30, which is stored and sent to the user's nominated email account.

As is shown in FIG. 9, the pin-hole cameras 30 may also be mounted to an accessory carried or worn by the user. In the embodiment as depicted the cameras 30 are mounted to a user's handbag 6 which may be carried by the user. The handbag 6 may also typically carry the user's device 15, 18 which is able to communicate with each of the cameras 30. Each of the cameras 30 are typically mounted to the handbag 6 so as to capture multiple views of the user's environment as depicted by the arrows. It will be appreciated that the cameras 30 may also be mounted to a jacket or hat worn by the user as well as to a satchel or backpack carried by the user.

With the present system as described above, the system can also be employed in a shopping environment to facilitate secure transactions between the user and a vendor. In such an arrangement, the user can select the SHOP icon from the screen page depicted in FIG. 4, at which time the cameras will be activated to take a video/audio recording of the transaction as proof of purchase. The user is also able to make a payment to the vendor via the software application and the vendor can download the receipt to the user via Bluetooth or the network, as proof of payment. The present system also has application for use as an ID confirmation service for venues such as pubs, clubs and the like. To use this service, the user is able to activate the ID FOR VENUE button as depicted in the screenshot of FIG. 4.

Once activated, the user's stored photographic ID image is displayed on their device 15, 18, typically a photographic image of their driver's license or passport. The venue can then review the photographic ID to confirm the user's identification and a copy of the user's details may be supplied to the venue's software application if the user allows such a transmission. The user and the venue can then transfer information between devices, such as any cover charge information or conditions of entry, as required.

Referring again to FIG. 4, the present system also provides the registered user with a video or photo transfer system for improving the user's personal security. To activate this feature the user is able to select the appropriate icon from the screenshot of FIG. 4.

The video or photo transfer system application provides the user with a system that can be used by the user on business trips, holidays, social gatherings and other public events, where there may be a need for people to video-record (contains audio) their surrounding when walking, running, travelling in any vehicle, working, or in any life situation. By taking a recording of such activity as the user is performing the activity, the recordings are able to be uploaded to a host service where the recording can be remotely monitored by a dedicated person who is able to identify a safety issue and render assistance should the user's safety be compromised. In an alternative aspect, the recording can be uploaded and saved at a host service where it can be kept for sentimental value. It will be appreciated that the user of the present system can nominate the email addresses to which the recorded video footage is to be sent.

As previously discussed, the user is able to use the camera(s) of their smart phone or personal electronic device to capture the recorded image(s) or may use pin-hole cameras mounted on their body or clothing or on a handbag or satchel carried by the user, as previously discussed. The recorded images taken will then be emailed to the user's nominated destination(s) together with geo-location data and time data associated with the recorded image as generated by the user's smart phone or personal electronic device. This information can be used by authorities in the event of an emergency or investigation.

In setting up the present system, the user can also nominate emails for emergency situations. By selecting a dedicated Emergency Button for a pre-determined time e.g. 5 seconds, an email requesting assistance with the video taken at the time of selecting the Emergency Button, together with geo-location, time & date data will be sent to email addresses nominated by the user as ‘emergency emails’. The recordings, once emailed, shall be automatically deleted from the user's personal electronic device or smart phone, ensuring that the device's internal storage is not depleted and that should anyone else having access to the mobile device will not see those videos for privacy reasons.

The user is able to select the duration of the video recordings to be emailed e.g. from 10 seconds, 20 seconds 30 seconds to 1 minute. Immediately after a video recording has been transmitted by the software application, a new video will commence recording. This process will continue until the user decides to turn off the application. It will be appreciated that the operation of the present invention relies on an active internet connection. Should such a connection fail, the application will continue to record videos, for the duration chosen, and attempt to send the emails once the internet connection returns.

It will be appreciated that the system and method of the present invention provides a simple and effective means for enhancing security and safety in a variety of different environments. The ability to record the individual's immediate environment and to transmit that recording, in real time, to a dedicated destination, such as an email address or other remote service, ensures that even in the event of a breach of the individual's safety, the relevant authorities will be provided with video and or audio recording of the individual at the time the breach occurred.

In relation to a transaction relationship, by providing a system that stores important information about each party involved in the transaction and which provides a simple and effective means for transmitting that information between each party, each party is fully apprised about the details of the other to complete the transaction. The system and method also enables video/audio recordings of any transaction or situation desired by the user, whereby a copy of the recording is sent to one or more of the user's contacts. This also provides a simple and effective means for maintaining personal safety and for recording situations for security purposes.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the device uppermost.

It will be appreciated by those skilled in the art that many modifications and variations may be made to the methods of the invention described herein without departing from the spirit and scope of the invention.

1. A personal safety system comprising:
a personal electronic device carried by an individual having one or more sensors for recording visual and/or audio data associated with the individual;
at least one external service nominated by the individual to be in electronic communication with the personal electronic device to receive and store the recorded visual and/or audio data from the personal electronic device in real time for monitoring purposes; and
wherein, the visual and/or audio data is continuously recorded in discrete predetermined intervals by the personal electronic device and at the completion of each discrete predetermined interval the visual and/or audio data for that discrete predetermined interval is transmitted to the external service together with data capturing the time and location of the individual, and following transmission of the visual and/or audio data, the data is deleted from the personal electronic device.

2. A personal safety system according to claim 1, wherein the at least one external service nominated by the individual is in electrical communication with the personal electronic device by way of an email address, such that the recorded visual and/or audio data is transmitted to the at least one external service from the personal electronic device by email.

3. A personal safety system according to claim 1, wherein the personal electronic device is activated to commence recording visual and/or audio data by the individual selecting a dedicated emergency button for a pre-determined time.

4. A personal safety system according to claim 3, wherein upon selection of the dedicated emergency button on the personal electronic device, the personal electronic device further records the geo-location, time and date data of the recording for transmission to the one or more external services.

5. A personal safety system according to claim 1, wherein the discrete time intervals in which the visual and/or audio data is recorded and transmitted to the external service are determined by the individual.

6. A personal safety system according to claim 1, wherein immediately after transmission of the visual and/or audio data to the remote service, a new discrete predetermined interval of visual and/or audio data is commenced.

7. A personal safety system according to claim 1, wherein the personal electronic device is configured to communicate with one or more body worn sensors to receive the visual and or audio data associated with the individual.

8. A personal safety system according to claim 7, wherein the one or more body worn sensors are mounted on clothing worn by the individual or items carried by the individual.

9. A method for improving personal safety and security of individuals involved in a transaction comprising:
configuring a personal electronic device of each individual to contain personal information about said individual;
assigning each personal electronic device with a unique identifier to be used to facilitate engagement between each individual's personal electronic device;
initiating transaction upon engagement between each individual's personal electronic device, such that:
the other individual's personal information is displayed and stored on the individual's personal electronic device;
an audio or video recording is initiated on the individual's personal electronic device to record the transaction;
completing transaction between the individuals such that:
payment is transmitted between the engaged personal electronic devices of the individuals;
a receipt is transmitted between the engaged personal electronic devices of the individuals confirming received payment;
the receipt, personal information of the other individual and the video or audio recording of the transaction is transmitted to a nominated storage facility of the individual; and
the personal electronic devices the individuals are disengaged to complete transaction.

10. A method according to claim 9, wherein the transaction is between a driver of a vehicle for hire and a passenger intending to hire said vehicle.

11. A method according to claim 10, wherein the driver's personal information includes registration details of the vehicle, license details of the driver and authorisation details of the driver.

12. A method according to claim 10, wherein the passenger's personal information includes formal photographic identification of the passenger and intended destination of the passenger.
